(19) United States
(12) Patent Application Publication
(10) Pub. No.: US 2015/0348085 A1
(43) Pub. Date: Dec. 3, 2015

(54) REBATE PROCESSING AND DATA COLLECTION SYSTEM AND METHOD

(71) Applicants: Benjamin C. Hendricks, Pottstown, PA (US); Ero K. Selander, Lansdale, PA (US); Dan J. Donnelly, Beaver Falls, PA (US)

(72) Inventors: Benjamin C. Hendricks, Pottstown, PA (US); Ero K. Selander, Lansdale, PA (US); Dan J. Donnelly, Beaver Falls, PA (US)

(73) Assignee: AKTIEBOLAGET SKF, Goteborg (SE)

(21) Appl. No.: 14/724,942

(22) Filed: May 29, 2015

Related U.S. Application Data
(60) Provisional application No. 62/005,729, filed on May 30, 2014.

(51) Int. Cl. G06Q 30/02

(52) U.S. Cl. CPC G06Q 30/0234

(57) ABSTRACT

Systems, methods, and computer-readable media for rebate processing are provided. For example, the method includes receiving a plurality of rebate requests comprising a plurality of fields, with the plurality of rebate requests being associated with a distributor. The method also includes normalizing the plurality of fields to generate a plurality of normalized fields, determining, using a processor, whether to issue a rebate by applying of the plurality of rules to the plurality of normalized fields, and determining, using the processor, sales information related to sales activities of the distributor based on the plurality of rebate requests.

### CROSS-REFERENCE TO RELATED APPLICATIONS

This application claims priority to U.S. Provisional Patent Application having Ser. No. 62/005,729, filed on May 30, 2014. The entirety of this priority provisional application is incorporated herein by reference.

### BACKGROUND

Rebates can be used in consumer settings and in industrial settings to competitively adjust prices, provide incentives for selling certain products, e.g., in certain geographic areas, etc. The consumer setting may be the most familiar setting, in which a consumer purchases a product and mails in a rebate card, along with proof of purchase, to a manufacturer, retailer, etc. In industrial settings, however, a manufacturer typically sells one or more products to distributors, who in turn sell to end-users. Part of some distribution agreements between distributors and manufacturers may include the manufacturer providing rebates for particular products sold. The agreements may also stipulate that, to be eligible for the rebate, the products must be sold during a certain period of time, to a certain end-user, in a certain geographic area, etc.

The distributor may submit rebate requests to the manufacturer for the products sold under the agreement. These requests are typically in the form of a spreadsheet, which lists the products and/or any other relevant terms. These spreadsheets are then reviewed by the manufacturer, often manually, to verify that a rebate is owed for the request, e.g., that the sales comply with the terms of the rebate agreement.

A given manufacturer may have multiple rebate agreements in place with multiple distributors. Accordingly, processing of the rebate requests, especially when done by hand, may be time-intensive and error-prone. Moreover, manufacturers generally budget for rebate usage, allocating rebate budgets according to expected utilization. In this way, rebate dollars that are expected to be sent back to the distributor are committed in the budget. Under-utilization and over-utilization may mean that rebate dollars should be re-allocated.

### SUMMARY

Embodiments of the disclosure may provide a method for rebate processing. For example, the method includes receiving a plurality of rebate requests including a plurality of fields, with the plurality of rebate requests being associated with a distributor. The method also includes normalizing the plurality of fields to generate a plurality of normalized fields, determining, using a processor, whether to issue a rebate by applying of the plurality of rules to the plurality of normalized fields, and determining, using the processor, sales information related to sales activities of the distributor based on the plurality of rebate requests.

Embodiments of the disclosure may also provide a computer system. The computer system includes one or more processors, and a memory system comprising one or more computer-readable media storing instructions that, when executed by at least one of the one or more processors, cause the computer system to perform operations. The operations include receiving one or more proposed rules related to an agreement with a distributor, and transmitting the one or more proposed rules to an approval entity. The operations also include receiving an indication of approval from the approval entity of the one or more proposed rules, and in response to receiving the indication of approval, establishing one or more rules based on the one or more proposed rules. The operations further include receiving a plurality of rebate requests comprising a plurality of fields. The plurality of rebate requests are associated with the distributor. The operations also include normalizing the plurality of fields to generate a plurality of normalized fields. The operations additionally include determining whether to issue a rebate by applying the one or more rules to the plurality of normalized fields.

It will be appreciated that the foregoing summary is intended merely to introduce certain aspects of the disclosure. These and other aspects are more fully described below. As such, this summary is not intended to be limiting on the claims.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a rebate system, according to an embodiment.

FIG. 2 illustrates a schematic view of the rebate system in the context of a market, illustrating the flow of data and/or products, according to an embodiment.

FIG. 3 illustrates a flowchart of a method for processing rebate requests, according to an embodiment.

FIG. 4 illustrates a flowchart of method for establishing a rebate agreement, according to an embodiment.

FIG. 5 illustrates a flowchart of a method for displaying renewal information based on sales information, according to an embodiment.

FIGS. 6-17 illustrate simplified, conceptual views of dashboards for displaying sales metrics based on sales information, according to various embodiments.

FIG. 18 illustrates a schematic view of a computing system, according to an embodiment.

### DETAILED DESCRIPTION

The following detailed description refers to the accompanying drawings. Wherever convenient, the same reference numbers are used in the drawings and the following description to refer to the same or similar parts. While several embodiments and features of the present disclosure are described herein, modifications, adaptations, and other implementations are possible, without departing from the spirit and scope of the present disclosure.

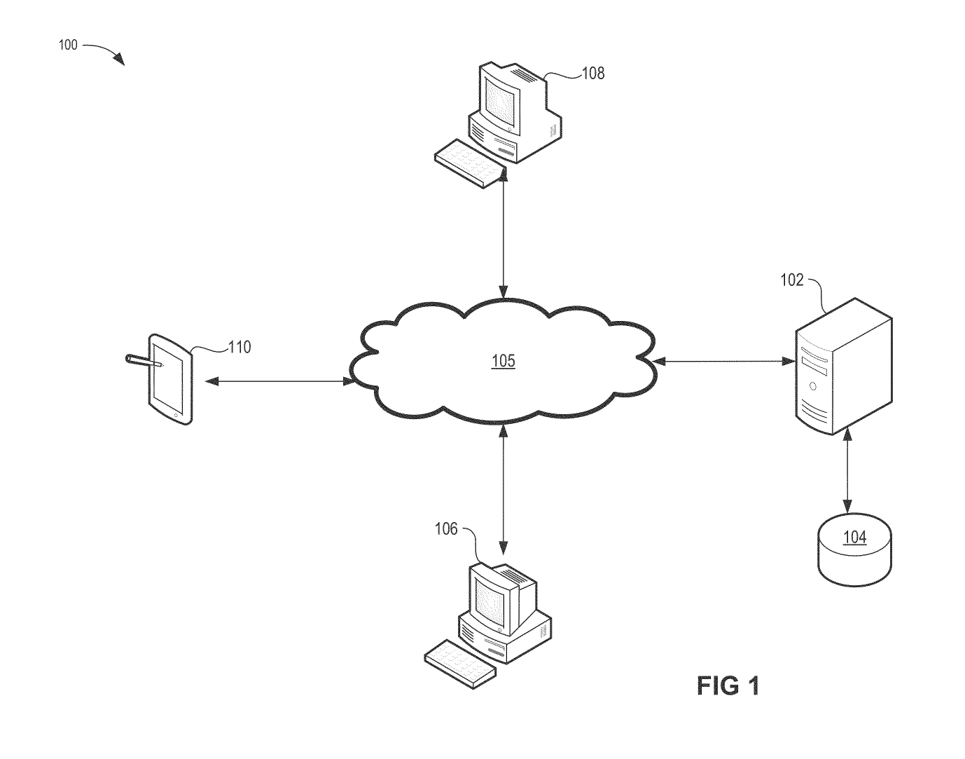

FIG. 1 illustrates a schematic view of a rebate system 100, according to an embodiment. The system 100 may generally include a rebate processing system 102, which is linked to (e.g., includes) a database 104. The rebate processing system 102 may be or include one or more servers or other types of computers or computing devices, networks thereof, combinations thereof, and/or the like. Further, although illustrated as directly linked to the rebate processing system 102, the database 104 may be remote from the rebate processing system 102, or internal to the rebate processing system 102, in any suitable configuration. The rebate processing system 102 may communicate with the database 104, so as to store information thereon and receive information therefrom. The database 104 may store sales information, e.g., in association with distributors, salespersons, products, etc. Further, the database 104 may store sales metrics in association with similar entities and/or others. Examples of such metrics and calculation thereof will be described in greater detail below.

The rebate processing system 102 and/or the database 104 may be coupled with a network 105 via any suitable data link(s), whether wired or wireless. The network 105 may be a wide-area network, such as the internet, and may include any number of computers, routers, switches, etc. In certain embodiments, the network 105 may also be or include one or more local-area network(s).

The rebate system 100 may also include a manufacturer system 106. The manufacturer system 106 may be or include one or more computers, servers, combinations thereof, networks thereof, etc., which may also be in communication with the network 105. Accordingly, the manufacturer system 106 may be remote from the rebate processing system 102 and/or the database 104, for example, the manufacturer system 106 may not be located in the same facility, geographical area (e.g., city, state, country, etc.) as the rebate processing system 102. One of skill in the art will appreciate that “remote” is not intended to convey any certain absolute distance.

In an embodiment, the manufacturer system 106 may communicate with the rebate processing system 102 via a web portal, which may establish an interface between a user positioned at the manufacturer system 106 and one or more applications executing on the rebate processing system 102. Such interface may be established using a stand-alone application, via a web browser, part of another application, or in any other manner. In other embodiments, the application may execute on the manufacturer system 106, which may fetch data from the database 104 and/or the rebate processing system 102 e.g., using any communication protocol.

The rebate system 100 may further include a distributor system 108. The distributor system 108 may be or include one or more computers, servers, combinations thereof, networks thereof, and/or the like. Further, the distributor system 108 may be coupled with the manufacturer system 106 via the network 105 (or via another, separate network) using any suitable wired or wireless communications link. In an embodiment, the distributor system 108 may also communicate with the rebate processing system 102, e.g., via a web portal. For example, the web portal used by the distributor system 108 may be the same web portal used by the manufacturer system 106, with the distributor (e.g., the user of the distributor system 108) having different access credentials for the web portal than the manufacturer (e.g., the user of the manufacturer system 106). In other embodiments, separate web portals may be maintained, or web portals may not be used.

The rebate system 100 may also include a sales device 110. The sales device 110 may be coupled with the network 105, e.g., via a cellular or other wireless communication link. Further, the sales device 110 may be remotely located with respect to the manufacturer system 106, the distributor system 108, and/or the rebate processing system 102. In various embodiments, the sales device 110 may be a mobile device, such as a smartphone, tablet device, notebook computer, laptop computer, etc. Accordingly, at some times, the sales device 110 may be remote from one or more, or even all, of the manufacturer system 106, the distributor system 108, and/or the rebate processing system 102, but at other times, may be co-located or otherwise near to any of these systems, e.g., depending on the location of the user (e.g., the salesperson) of the sales device 110. The sales device 110 may also be configured to communicate with the rebate processing system 102 and/or the manufacturer system 106, e.g., via a web portal accessible via the network 105, which may the same as or different from the web portal accessible to either or both of the distributor system 108 and/or the manufacturer system 106.

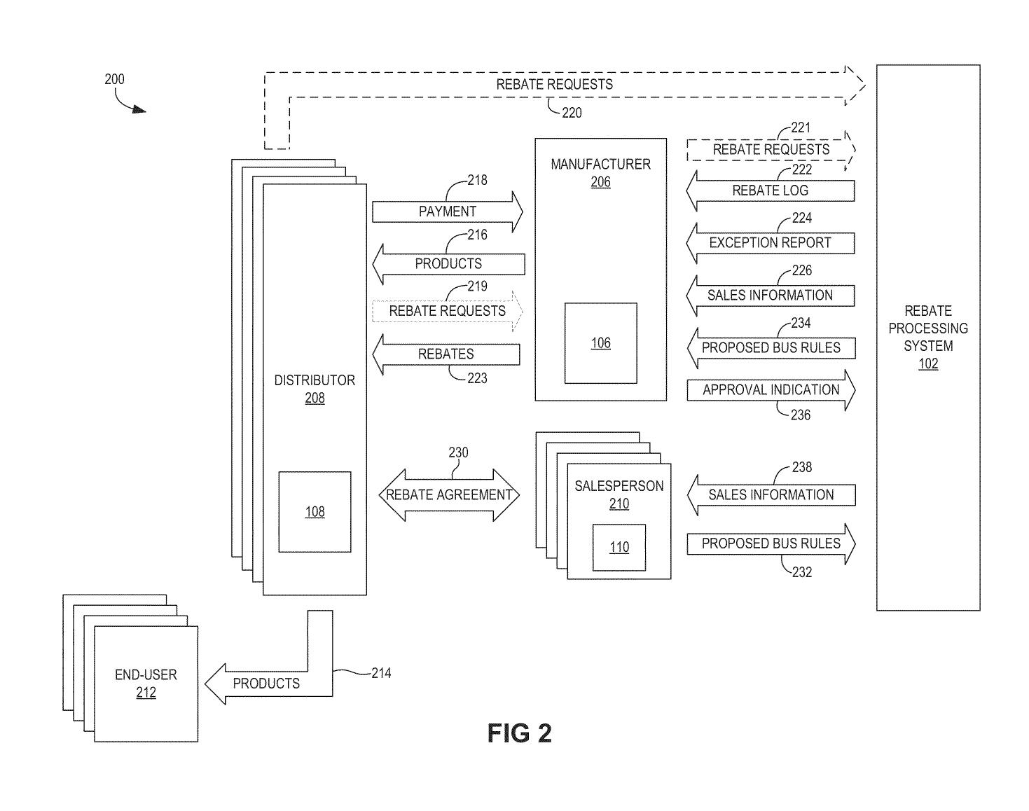

FIG. 2 illustrates another schematic view of the rebate system 100 in the context of a market 200, illustrating the flow of data and/or products, according to an embodiment. In the illustrated view, the market 200 includes the rebate processing system 102, a manufacturer 206, one or more (e.g., as shown, a plurality of) distributors 208, one or more (e.g., as shown, a plurality of) salespeople 210. Further, the manufacturer 206 may include the manufacturer system 106, the distributors 208 may each include the distributor system 108, and the salespeople 210 may each include (or have) the sales device 110. The market 200 also includes one or more (e.g., as shown, a plurality of) end-users 212. The distributors 208 may provide one or more products to the end-users 212, as indicated at 214, e.g., in return for payment. In some instances, the distributors 208 may also be end-users 212, and thus may not resell the products.

The manufacturer 206 may receive one or more orders, or pursuant to another business agreement, may provide products at 216 to the distributor 208. In turn, the distributor 208 may provide payment to the manufacturer 206, as indicated at 218. At some point, whether after making payment, receiving one or more (e.g., a certain number of) units of the product, at a certain time interval (e.g., monthly), or based on any other trigger, the distributor system 108 may, in an embodiment, submit one or more rebate requests to the manufacturer system 106, as indicated at 219.

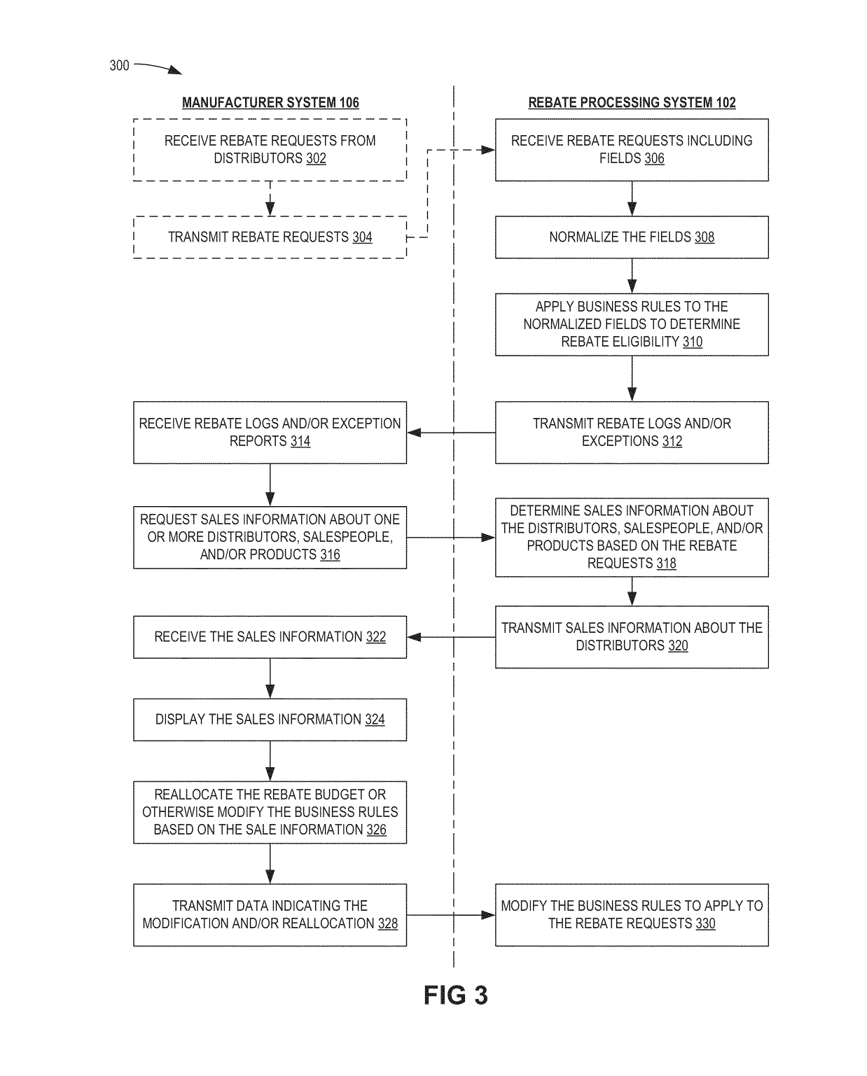

FIG. 3 illustrates a flowchart of a method 300 for processing rebate requests, according to an embodiment. Referring now to FIGS. 2 and 3, the manufacturer system 106 may receive the rebate requests from the distributor 208 (e.g., from the systems 108 thereof), as at 302. As noted above, in FIG. 2, this is indicated at 219. The manufacturer system 106 may then transmit the rebate requests to the rebate processing system 102, as at 304. This is illustrated in FIG. 2 at 221. In some cases, the manufacturer system 106 may perform certain verification, spot-checking, normalization, quality or fraud control, etc. on the rebate requests, but, in others, may provide the rebate requests to the rebate processing system 102 in unprocessed or “raw” format, e.g., as received from the distributor system 108. In other embodiments, the distributor system 108 may directly communicate the rebate requests to the rebate processing system 102, as indicated at 220, and thus blocks 302 and 304 in FIG. 3 may be omitted from the method 300. Receiving requests as indicated at 218 and at 220 may not be mutually exclusive, however. In some embodiments, one or some of the distributor systems 108 may submit rebate requests in one way, while others submit requests in the other way. In still other embodiments, one, some, or all of the distributor systems 108 may redundantly supply the rebate requests in both ways.

The rebate processing system 102 may receive the rebate requests, as at 306. In some embodiments, the rebate requests may have fields of data. The fields may include information relevant to the products that were sold. Such information may include data representative of the identity of the distributor 208, the identity of the end-user 212 to which the product was sold, the type of part or part number of the product, the geographical location/region of the end-user 212 to which the product was sold, the date of the sale to the end-user 212, the quantity of the product(s) sold, the industry of the end-user 212, or any other field. The fields may be configured to provide sufficient data to determine whether the sale to the end-user 212 by the distributor 208 is eligible for a rebate, based on the rebate agreements in place between the distributors 208 and the manufacturer 206.

The fields may not be uniformly formatted when received by the rebate processing system 102. For example, the fields may have different titles as between distributors 208, or may be arranged in different orders, have different data-types (e.g., text/char datatypes versus integer for dates), and/or may include different information, e.g., in order to satisfy the rebate agreements. Accordingly, the rebate processing system 102 may normalize the fields, as at 308, thereby generating normalized fields. Such normalization may proceed according to normalization rules that the rebate processing system 102 receives from the manufacturer 202, or a history of interactions with a particular distributor 208, such that the typical format of the distributor 208 may be expected (e.g., what the distributor titles a particular field in its rebate request file), or both. The normalization may result in normalized fields, which may be normalized according to certain standards that may be specified by the distributor 208 and/or the rebate processing system 102. Any suitable normalization technique may be employed, without limitation.

The rebate processing system 102 may also include business rules that, e.g., may be stored in the database 104 (FIG. 1). The business rules may be established by the details of the agreement between the manufacturer 206 and the distributor 208. The rebate processing system 102 may apply the business rules, as at 310, to the normalized fields to determine rebate eligibility.

The business rules may include part numbers, date ranges, eligible end-users, geographic areas, end-user industries, part type, part numbers, amount sold, etc., which may be required to be satisfied for rebate eligibility for a sale. The business rules may also include an identity of a distributor 208 eligible for a rebate. In some embodiments, different sets of business rules may be established for different distributors 208 and associated therewith in the database 104. Thus, the rebate processing system 102 may, in some embodiments, begin by determining which set of rules to apply based on the identity of the distributor 208. Further, the business rules may establish a rebate amount, e.g., per product, according to sales thresholds, etc. to be paid to a distributor 208 in response to an eligible, verified rebate request.

Once the rebate requests are verified, the rebate processing system 102 may compile rebate logs and/or exceptions that may be transmitted, as at 312, to the manufacturer 206. This is illustrated at 222 and 224 in FIG. 2. Rebate logs may include lists of rebate requests that are verified, and/or may otherwise indicate a rebate amount owed to one or more distributors 208 in response to rebate requests submitted by these distributors 208. Exceptions may be representative of rebate requests that are rejected based on the business rules. The manufacturer system 106 may receive the logs and/or exceptions, as at 314. The manufacturer 206 may employ the logs and/or exceptions to remit payment of the appropriate rebate amounts to the distributor 208, as indicated at 223. In other embodiments, the rebate processing system 102 may handle the payment of the rebates automatically.

The rebate requests may provide information and insight into the sales activities of the distributors 208 making the requests, and also into the end-user market for the products being sold. Accordingly, the manufacturer system 106 may request sales information about a distributor 208, a salesperson 210, and/or a product, as at 316. Generally, such sales information may include rebate budget utilization. Briefly, as mentioned above, rebates may be budgeted similar to any other type of expense. Portions of the budget may be allocated according to agreements with the distributors 208 and may be considered “tied up” or otherwise not available for agreements with other distributors 208 or for other products. This may avoid over-extending expenditures on rebates. On the other hand, if a certain distributor 208 does not request rebate amounts at or near the total of the allocation, the shortfall represents a portion of the rebate budget that could have been committed to other distributors 208 and/or products. Accordingly, such sales information may provide data that is helpful in determining how to reallocate budget amounts among distributors, products, salespeople, etc.

Further, the sales information may also include a historical utilization in association with, e.g., the rebate amount. Thus, information representing a price elasticity of the product may be developed, and, through such information, it may be seen that a certain rebate allows distributors 208 to sell a certain number more of the product. Conversely, if the rebate amounts have changed, but the total rebates requested reflect that approximately the same amount of product has been sold, it may be concluded that the price is relatively inelastic, at least in the price range with historical data available. Thus, rebate allocation decisions may be made in view of a historical knowledge of how the rebate allocation will affect sales of a certain product or by a certain distributor, in a certain region, etc. These numbers may be cross-referenced with other factors (economic conditions, natural conditions, etc.) so an accurate view of the sales environment, and the likelihood of an impact that the rebate allocation will have, may be determined.

Further, the sales information may provide a metric for evaluating salesperson performance. If a salesperson 210 is misallocating, or recommending poor allocations of, rebate budgets, it may be apparent based on the analysis of the sales information. This may trigger a review of the practices for determining rebate budget allocation by the salesperson, training, etc.

For example, metrics may be calculated for salespeople 210 based on the distributors 208 for which they are responsible. As such, in an embodiment, one or more of the distributors 208 may be associated with a salesperson 210 in the database 104. The distributors 208 may also be associated with a rebate budget amount which has been allocated to the distributors 208, and a used rebate amount based on requests submitted. The salesperson 210 may also have a rebate budget allocated, and a used rebate amount for the salesperson 210 may be calculated by summing the rebate usage of the distributors 208 for which the salesperson 210 is responsible. A comparison of the rebate budget associated with the salesperson 210 and the rebate usage of the distributors 208 for which the salesperson 210 is responsible may thus be displayed, providing a metric indicating a performance of the rebate agreements associated with the salesperson 210.

Accordingly, the method 300 may provide for the rebate processing system 102 to determine sales information about the distributor 208, the product, the salesperson 210, or a combination thereof, based on the rebate requests, as at 318. In other embodiments, the rebate processing system 102 may provide the raw data to the manufacturer system 106, which may conduct the analysis. In the illustrated embodiment, however, the rebate processing system 102 may carry out the analysis, and then transmit, at 320, the determined sales information to the manufacturer system 106 as depicted in FIG. 2 at 226.

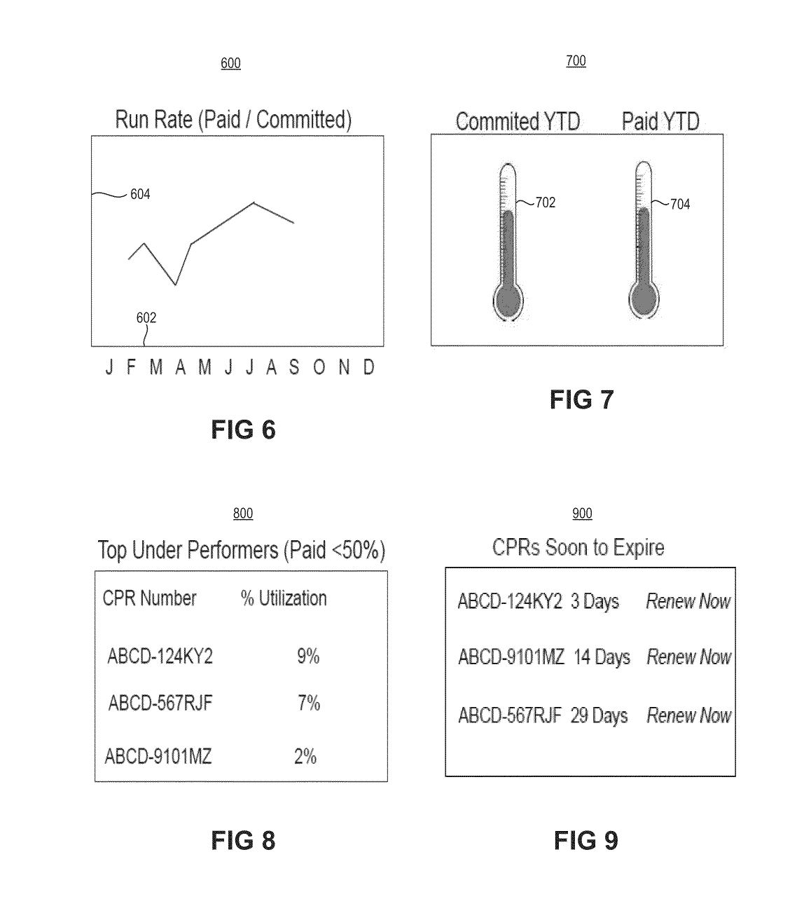

The manufacturer system 106 may, in turn, receive the sales information at 322 and display the sales information at 324. Accordingly, the transmission of the sales information at 320 may also be considered “causing” the sales information to be displayed, e.g., at the manufacturer system 106. The sales information may be displayed in any of a variety of formats, such as the dashboards described below with respect to FIGS. 6-17.

Instead of or in addition to displaying the sales information at the manufacturer system 106, the manufacturer system 106 may transmit the sales information to the sales device 110, and/or the rebate processing system 102 may transmit the sales information to the sales device 110, causing the sales device 110 to display the information. This may provide remote access to such information to the salespeople using the sales devices 110. In some cases, the displaying on the manufacturer system 106 and/or the sales devices 110 may proceed by transmission to a web portal, web application, or any other application executing at least partially on the manufacturer system 106 and/or the sales devices 110, as noted above.

The method 300 may also include reallocating the rebate budget or otherwise modifying the business rules based on the sales information, as at 326. In some cases, this may proceed automatically, e.g., according to manufacturer 206 and/or salesperson 210 preferences. This may provide, for example, options to either entity, e.g., to maximize sales of one product, reward or prefer a certain distributor, etc. Such preferences may inform automated decision-making. In another embodiment, the users may reallocate the budgets in a more manual process, which may include adjusting allocations manually in the system. In either case, the historical data metrics provided in the sales information may assist in forecasting the effect of such reallocations.

For example, the rebate processing system 102, the manufacturer system 106, the sales device 110, or the respective users thereof, may use the rebate requests and/or logs to calculate a used rebate amount for a distributor 208, product, product type, industry, etc. The used rebate amount may be compared to the amount of rebate budgeted or allocated, to determine the utilization rate. If the used rebate amount is different (above or below) the budgeted amount by a certain threshold, it may indicate that rebate budget reallocation is warranted. The threshold may be a concrete amount of difference between budgeted and used rebate amounts, a percentage of either, or the like. If reallocation is deemed warranted, the rebate budgets may be modified, e.g., by decreasing the budget allocated to one or more under-utilizing distributors 208, products, industries, etc., and/or increasing the budget allocated to one or more over-utilizing distributors 208, products, industries, etc.

Furthermore, the impact of budget reallocations may be determined by tracking rebate requests/payments in association with the rebate amounts. This may provide insight into price elasticity, as mentioned above, of a product subject to the rebate, taking into account other considerations, for example, such as geography or industries of the end-users 212 serviced by the distributor 208, to name just two among many possible considerations. Thus, the reallocation may include changing the amount of rebate per request or product sold, thereby either changing the margin on resale or the price point for the product, or both.

Returning to FIG. 3, if a reallocation is determined at 326 (e.g., and conducted), the method 300 may proceed to transmitting data indicating the modification and/or reallocation, as at 328. In some cases, this may occur after determining that the rules are modifiable, e.g., at the conclusion of the term of a rebate agreement, as will be discussed in greater detail below. In turn, the rebate processing system 102 may receive the modifications and modify the business rules to apply to the rebate requests going forward.

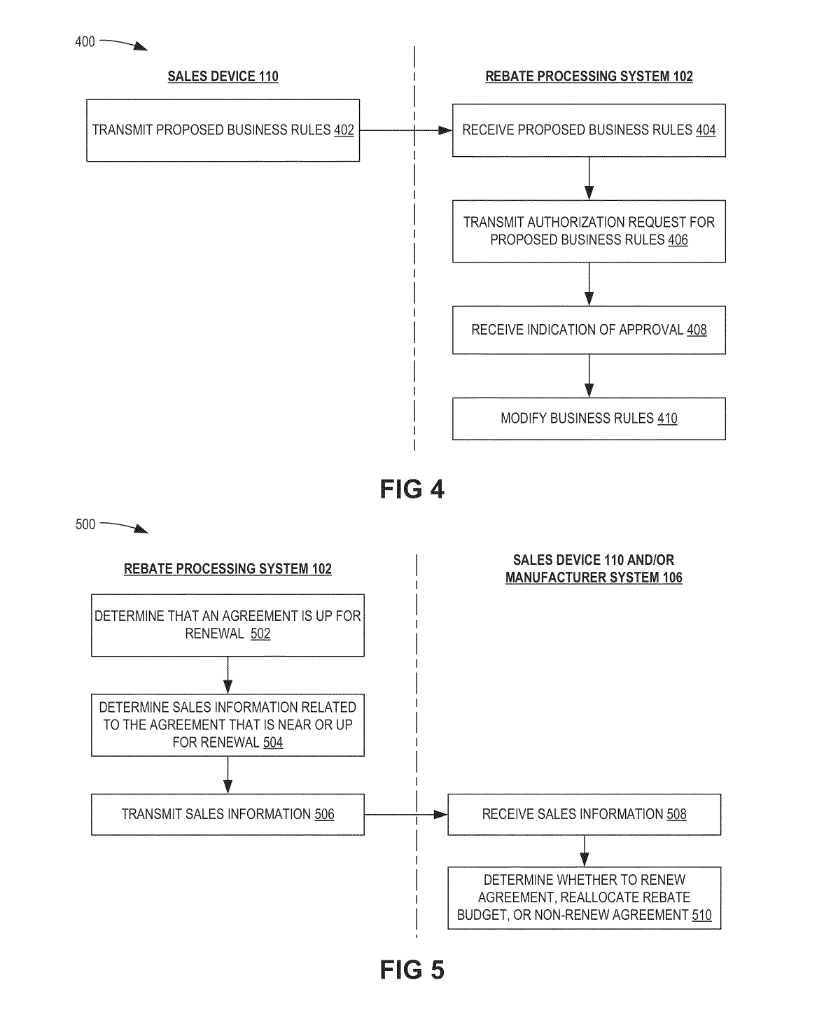

With continuing reference to FIG. 2, FIG. 4 illustrates a flowchart of a method 400 for establishing a rebate agreement, e.g., using the rebate processing system 102, according to an embodiment. The method 400 may begin at the close of an agreement, e.g., between the salesperson 210 and the distributor 208, as indicated at 230 in FIG. 2. For example, the agreement may stipulate certain rebate eligibility requirements, from which proposed business rules may be determined or otherwise related. For example, such requirements/rules may include distributor identity, eligible part numbers, part types, dates, geographic areas, end-users (e.g., type, industry, geography, branch, etc.), and/or the like. The rules may be entered into the sales device 110, e.g., through the web portal or another user interface, which may include drop-down menus, radio buttons, text fields, and/or the like. The interface may thus provide a guided entry of the terms of the agreement, allowing for the business rules to be determined. Moreover, the interface may provide historical sales information (e.g., rebate utilization) for the distributor, part number, geographic area, etc., as will be described in greater detail below, which may assist the salesperson 210 in arriving at the rebate agreement 230.

The method 400 may then begin with the salesperson 210, e.g., using the sales device 110, transmitting the proposed business rules, as at 402, to the rebate processing system 102. An example of this transmission is indicated at 232 in FIG. 2. In some embodiments, however, the proposed business rules may first be transmitted directly to the manufacturer system 106, for manufacturer 206 approval before entry into the rebate processing system 102.

The rebate processing system 102 may receive the proposed business rules, as at 404. In an embodiment in which the rebate processing system 102 receives the proposed business rules from the sales device 110 (or from the distributor system 108), the rebate processing system 102 may transmit an authorization request for the proposed business rules, e.g., to the manufacturer system 106 or another “approval entity” (e.g., any person, organization, or computer with decision-making authority), as at 406. This transmission is indicated at 234 in FIG. 2. The authorization request may include at least some of the proposed business rules, which may be reviewed by the approval entity and accepted, modified, or denied. If the proposed business rules are modified or denied, a signal may be sent to the salesperson 210 (e.g., the sales device 110) and/or to the distributor system 108, indicating the denial, proposing modifications, etc. This signal may be relayed by the rebate processing system 102, e.g., through the interface, or may be sent directly from the manufacturer system 106, to the sales device 110.

If the approval entity (e.g., the manufacturer 206) approves the proposed business rules, the rebate processing system 102 may receive an indication of approval of the business rules therefrom, as at 408. An example of this transmission is indicated at 236 in FIG. 2. In response, the rebate processing system 102 may access the database 104, which may store the business rules in association with the distributor 208, product identifier (e.g., part number), etc. The rebate processing system 102 may then modify the business rules in the database 104 using the approved business rules, as at 410. Further, the rebate processing system 102 may send a signal to the sales device 110 and/or to the distributor system 108, indicating that the proposed business rules were accepted and/or implemented into the database 104. The modified business rules may then be used, e.g., in the method 300 at block 310 (FIG. 3).

Still referring to FIG. 2, FIG. 5 illustrates a flowchart of a method 500 for displaying renewal information based on sales (rebate) information stored in the database 104, according to an embodiment. The method 500 may begin automatically, e.g., by the rebate processing system 102 reviewing the various agreement terms and determining that one or more of such agreements are near or up for renewal, as at 502. “Near or up for renewal” generally means that the agreements expire within a certain threshold amount of time or have already expired, for example, that the agreement expires within a certain number of months (e.g., one month), weeks, days, etc. This may provide a convenient time to adjust or re-allocate rebate budgets, e.g., as described above with respect to block 326 of FIG. 3, due to over-utilization, under-utilization, or changed manufacturer goals, among other reasons. In other embodiments, the method 500 may begin manually, e.g., when requested by the distributor system 108, the manufacturer system 106, and/or by the sales device 110, or in response to a prompt or list indicating agreements that are near or up for renewal.

Upon such automatic or manual start, the method 500 may include the rebate processing system 102 determining sales information related to the agreement that is determined to be near or up for renewal, as at 504. Such determining at 504 may proceed by accessing calculations of metrics made during the rebate-processing method 300, and stored, e.g., in the database 104. In other embodiments, the sales information may be calculated on-demand, when needed, from raw sales data that is stored during the rebate-processing method 300. In this case, the determining at 504 may include accessing raw rebate sales information and calculating metrics to assist in the renewal process. Such metrics may include historical sales data related to utilization of rebate budgets and trends in utilization, as related to the distributor 208 that is a party to the agreement, the region, the industry, relevant end-users, etc.

The method 500 may also include transmitting such sales information to the sales device 110 and/or to the manufacturer system 106, as at 506. An example of transmission of sales information (e.g., related to a particular distributor 208) is shown in FIG. 2 at 238. Further, the sales information is also depicted in FIG. 2, at 226, being transmitted to the manufacturer system 106, as noted above. This transmission may include, for example, causing the sales information to be displayed on the sales device 110 and/or the manufacturer system 106, e.g., through the aforementioned web portal, or any other interface. In other embodiments, the sales information may be provided to the sales device 110 and/or to the manufacturer system 102 as raw rebate information, which may be processed to determine the metrics by an application executing on the manufacturer system 106 and/or by an application executing on the sales device 110. Further, sales information may be transmitted as indicated at 226 and/or 238 outside of the context of renewal, e.g., for monitoring rebate utilization, price setting, etc.

The sales device 110 and/or the manufacturer system 106 may receive the sales information, as at 508. If in raw format, the receiving sales device 110 and/or manufacturer system 106 may perform any necessary calculations to determine relevant metrics. Using the metrics (whether calculated by the rebate processing system 102, or by the receiving device 110 and/or system 106), the salesperson 210 and/or manufacturer 206 may determine whether to renew the agreement, and under what terms, reallocate rebate budgets, or non-renew the agreement.

FIGS. 6-17 illustrate simplified conceptual views of dashboards showing the metrics calculated from the sales information, as discussed above. The dashboards may be provided on a single or multiple pages, windows, or views, and may be provided as part of a web portal, application, etc., on the sales device 110, manufacturer system 106, etc. Moreover, it will be appreciated that these dashboards are only a few representative examples among many contemplated and are not to be considered limiting, unless expressly stated otherwise herein.

Beginning with FIG. 6, there is illustrated a dashboard 600 showing a plot of run rates, which may be the amount of rebates paid under a certain agreement (e.g., to a certain distributor for a certain part sold in a certain area to an eligible end-user, etc.) divided by the amount allocated or “committed” to that agreement. Time (e.g., days, years, or, as shown, months) is on the horizontal axis 602, and percentage is on the vertical axis 604. The dashboard 600 may thus give a historical trend of rebate usage under an agreement, or by a distributor, by a part number, or according to any number or combination of variables, as collected during the rebate-processing method 300.

Similarly, FIG. 7 depicts a dashboard 700 showing a graphical comparison of rebate budget committed 702 and rebates paid 704. This may give an up-to-date, quick view, comparison of utilization.

FIG. 8 depicts a dashboard 800 showing the worst-performing (or “top under-performing”) utilization rates. The illustrated dashboard 800 shows the worst performing products, in terms of rebate utilization, and the associated rates of utilization. In other cases, this dashboard 800 may show the lowest utilization rates by distributor, region, industry, end-user, or any other subset of the information stored in the database 104. Furthermore, the dashboard may instead show the top over-performing (e.g., where paid exceeds committed).

FIG. 9 depicts a dashboard 900 showing a review of competitive price requests (CPRs) (e.g., agreements) that are nearing expiration. This may be employed, e.g., as part of method 500, for a user to determine agreements to renew, modify, or non-renew. Although shown by part number, the CPRs to renew may be indicated by distributor, or using any other identifier. Further, the dashboard 900 may provide a link for a user to “renew now” as shown, which may initiate the renewal method 500 in the portal or other program, as described above.

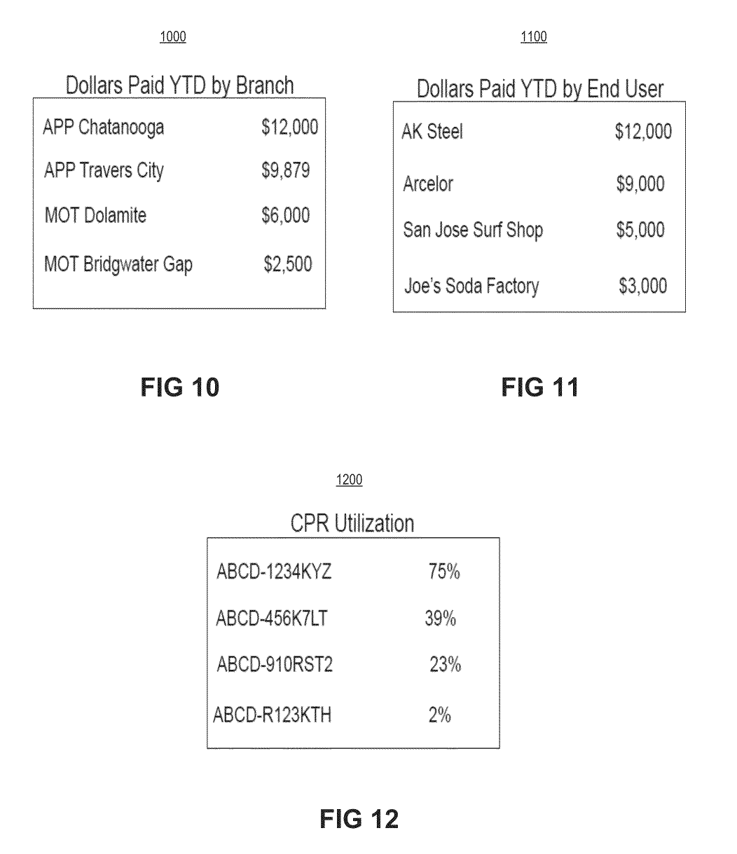

FIG. 10 depicts a dashboard 1000 which lists year-to-date amounts (e.g., dollars) paid to distributors. The level of granularity of the dashboard 1000 may be adjusted. For example, the illustrated dashboard depicts the branches, e.g., locations, of the distributors. In other cases, the dashboard 1000 may show the distributors in sum, by region, by division, by industry, or in any other level of detail. Further, the distributors (or sub-units thereof) may be listed in order of utilization or in any other manner.

FIG. 11 depicts a dashboard 1100 listing year-to-date sales amounts to end-users. The end-user sales may be associated with one or more distributors and/or one or more part numbers. This may provide sales information related to the market for particular parts, enabling the manufacturer to better forecast, determine causes of, or otherwise handle demand fluctuations.

FIG. 12 depicts a dashboard 1200, showing overall CPR utilization (e.g., amount paid divided by amount budgeted/committed) by part numbers, e.g., across one, some, or all distributors. This dashboard 1200 may give an overview of a market for a particular part.

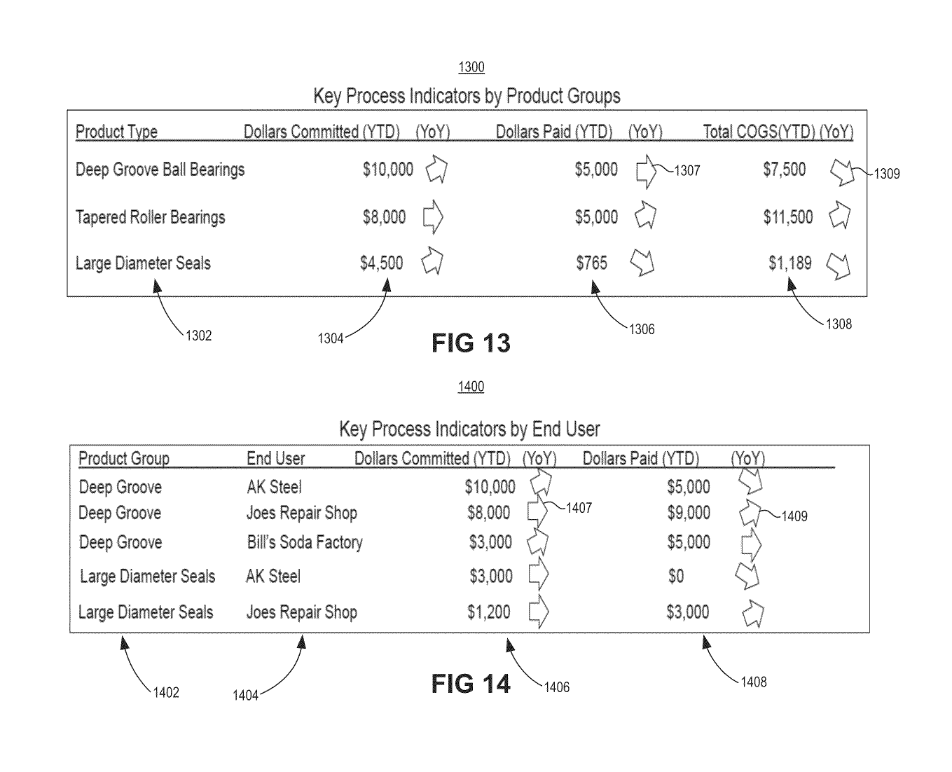

FIGS. 13 and 14 illustrate dashboards 1300 and 1400, respectively, showing “key process indicators” based on sales information collected during the rebate-processing method 300, according to an embodiment. The dashboard 1300 may include a list of product types (e.g., sets of products with common characteristics, uses, etc.) in a first column 1302, and an allocation in a rebate budget (dollars committed), e.g., during the current year, in a second column 1304. The second column 1304 may also include a visual indicator (e.g., arrow) 1305, showing the relationship to the same metric from a year before. In other embodiments, this may include a trend line across multiple years, color-coded information, etc., which may be employed to give a historical perspective to assist in identifying trends and assist in allocating rebate budgets.

The dashboard 1300 may also include a utilization amount (e.g., “dollars paid”) during the present year, in a third column 1306. Anther visual indicator 1307 may be provided next to entries in the third column 1306, which may provide historical, trend information related to the utilization amount. The dashboard 1300 may also include a fourth column 1308, which may indicate a total cost of goods sold (COGS) for the parts sold. The COGS may be the distributor's cost, i.e., the price at which the manufacturer 206 provides the products to the distributor 208. Another visual indicator 1309 may be provided next to entries in the fourth column 1308, so as to provide historical context for the entries in the fourth column 1308, when available.

The dashboard 1400 may also provide a first column 1402 indicating product types. The dashboard 1400 may also include a second column 1404, which may indicate end-users to which the product is sold. The dashboard 1400 may further provide a third column 1406 indicating an allocated budget amount (“dollars committed”) during the current year, for example, for the product group and end-user combination. The dashboard 1400 may additionally include a fourth column 1408 indicating a utilization rate for the product group and end-user combination. Visual indicators 1407 and 1409 may be provided next to entries in the third and fourth columns 1406, 1408, respectively, thereby providing historical context.

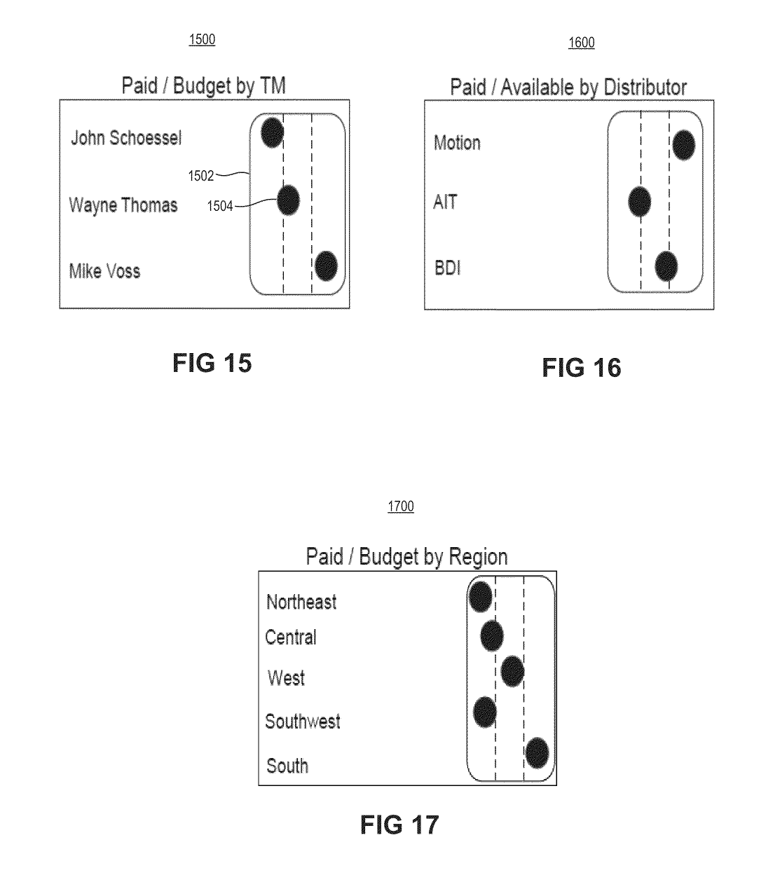

FIG. 15 illustrates another dashboard 1500, according to an embodiment. The dashboard 1500 illustrates a paid rebate amount versus committed (budgeted) rebate amount by salesperson. The paid vs. committed metric may be illustrated in a heat graph 1502 or other spatial depiction, which may be color coded, with dots 1504 representing the performance of each salesperson. In some embodiments, a sales manager of the manufacturer 206 may be able to review the activities of the sales force and determine if corrective action is warranted.

FIG. 16 depicts a similar dashboard 1600, illustrating paid versus budgeted by region, and FIG. 17 depicts a dashboard 1700 illustrating paid versus budgeted by distributor. It will be appreciated that such dashboards may be generated and displayed in association with product, distributor, branch, region, salesperson, industry, customer groups, product type, etc.

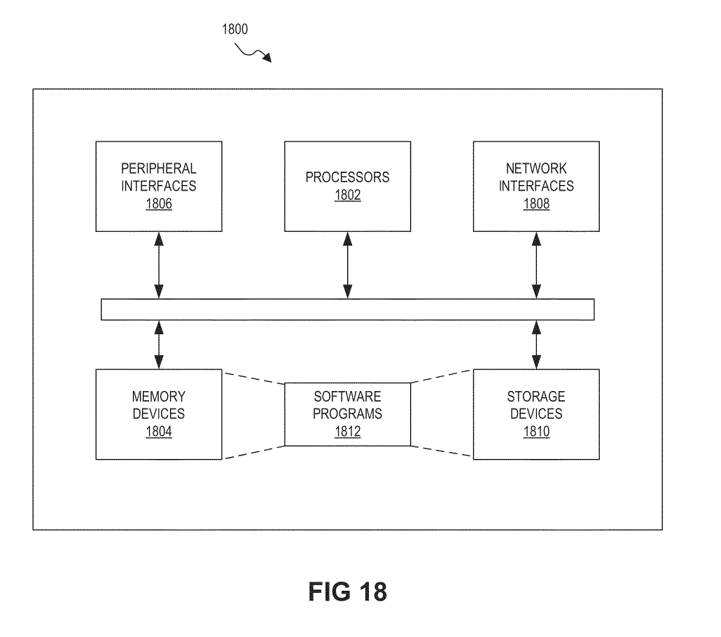

Embodiments of the disclosure may also include one or more systems for implementing one or more embodiments of the method of the present disclosure. FIG. 18 illustrates a schematic view of such a computing or processor system 1800, according to an embodiment. The processor system 1800 may include one or more processors 1802 of varying core (including multiple-core) configurations and clock frequencies. The one or more processors 1802 may be operable to execute instructions, apply logic, etc. It will be appreciated that these functions may be provided by multiple processors or multiple cores on a single chip operating in parallel and/or communicably linked together.

The processor system 1800 may also include a memory system, which may be or include one or more memory devices and/or computer-readable media 1804 of varying physical dimensions, accessibility, storage capacities, etc. such as flash drives, hard drives, disks, random access memory, etc., for storing data, such as images, files, and program instructions for execution by the processor 1802. In an embodiment, the computer-readable media 1804 may store instructions that, when executed by the processor 1802, are configured to cause the processor system 1800 to perform operations. For example, execution of such instructions may cause the processor system 1800 to implement one or more portions and/or embodiments of the methods 300, 400, and/or 500 described above.

The processor system 1800 may also include one or more network interfaces 1806. The network interfaces 1806 may include any hardware, applications, and/or other software. Accordingly, the network interfaces 1806 may include Ethernet adapters, wireless transceivers, PCI interfaces, and/or serial network components, for communicating over wired or wireless media using protocols, such as Ethernet, wireless Ethernet, etc.

The processor system 1800 may further include one or more peripheral interfaces 1808, for communication with a display screen, projector, keyboards, mice, touchpads, sensors, other types of input and/or output peripherals, and/or the like. In some implementations, the components of processor system 1800 need not be enclosed within a single enclosure or even located in close proximity to one another, but in other implementations, the components and/or others may be provided in a single enclosure.

The memory device 1804 may be physically or logically arranged or configured to store data on one or more storage devices 1810. The storage device 1810 may include one or more file systems or databases in any suitable format. The storage device 1810 may also include one or more software programs 1812, which may contain interpretable or executable instructions for performing one or more of the disclosed processes. When requested by the processor 1802, one or more of the software programs 1812, or a portion thereof, may be loaded from the storage devices 1810 to the memory devices 1804 for execution by the processor 1802.

Those skilled in the art will appreciate that the above-described componentry is merely one example of a hardware configuration, as the processor system 1800 may include any type of hardware components, including any necessary accompanying firmware or software, for performing the disclosed implementations. The processor system 1800 may also be implemented in part or in whole by electronic circuit components or processors, such as application-specific integrated circuits (ASICs) or field-programmable gate arrays (FPGAs).

The foregoing description of the present disclosure, along with its associated embodiments and examples, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments.

For example, the same techniques described herein with reference to the processor system 1800 may be used to execute programs according to instructions received from another program or from another processor system altogether. Similarly, commands may be received, executed, and their output returned entirely within the processing and/or memory of the processor system 1800. Accordingly, neither a visual interface command terminal nor any terminal at all is strictly necessary for performing the described embodiments.

Likewise, the steps described need not be performed in the same sequence discussed or with the same degree of separation. Various steps may be omitted, repeated, combined, or divided, as necessary to achieve the same or similar objectives or enhancements. Accordingly, the present disclosure is not limited to the above-described embodiments, but instead is defined by the appended claims in light of their full scope of equivalents. Further, in the above description and in the below claims, unless specified otherwise, the term “execute” and its variants are to be interpreted as pertaining to any operation of program code or instructions on a device, whether compiled, interpreted, or run using other techniques.

What is claimed is:

1. A computer-implemented method, comprising:
receiving a plurality of rebate requests comprising a plurality of fields, wherein the plurality of rebate requests are associated with a distributor;
normalizing the plurality of fields to generate a plurality of normalized fields;
determining, using the processor, whether to issue a rebate by applying of a plurality of rules to the plurality of normalized fields; and
determining, using the processor, sales information related to sales activities of the distributor based on the plurality of rebate requests.

2. The method of claim 1, further comprising reallocating a rebate budget based on the sales information.

3. The method of claim 2, wherein determining the sales information comprises:
calculating a used rebate amount based on the plurality of rebate requests;
comparing a budgeted rebate amount with the used rebate amount; and
determining that a difference between the budgeted rebate amount and the used rebate amount is at least a threshold,
wherein reallocating the rebate budget comprises modifying the budgeted rebate amount so that the difference between the budgeted rebate amount and the used rebate amount is less than or equal to the threshold.

4. The method of claim 2, wherein reallocating the rebate budget comprises:
decreasing a portion of the rebate budget associated with the distributor or a product sold by the distributor; and
increasing a portion of the rebate budget associated with another distributor or another product sold by the distributor.

5. The method of claim 2, further comprising:
comparing the sales information before and after reallocating the rebate budget; and
determining a price elasticity for a product sold by the distributor, based on comparing the sales information before and after reallocating the rebate budget.

6. The method of claim 1, wherein the plurality of rules comprises information indicative of at least one of:
an identity of the distributor eligible for a rebate;
a product sold by the distributor that is eligible for a rebate;
a time period during which a sale of a product is eligible for a rebate;
a geographic area in which a sale of a product is eligible for a rebate;
an end-user to which a sale of a product is eligible for a rebate; or
a rebate amount associated with a product.

7. The method of claim 1, wherein the sales information comprises an amount of a product sold by the distributor.

8. The method of claim 1, wherein the sales information comprises an amount of a product sold by the distributor in a certain geographic area.

9. The method of claim 1, wherein the sales information comprises an amount of a product sold by the distributor to a certain end-user.

10. The method of claim 1, further comprising adjusting the plurality of rules based on the sales information.

11. The method of claim 1, further comprising causing the sales information to be displayed.

12. The method of claim 11, further comprising:
associating a plurality of distributors, including the distributor, with a salesperson;
associating a first budgeted rebate amount with the plurality of distributors;
associating a second budgeted rebate amount with the salesperson; and
comparing the first and second budgeted rebate amounts,
wherein causing the sales information to be displayed comprises causing a comparison of the first and second rebate amounts to be displayed in association with the salesperson.

13. The method of claim 11, further comprising associating a budgeted rebate amount with a product and the distributor, wherein:
determining the sales information comprises:
calculating a used rebate amount for the product sold by the distributor; and
comparing the used rebate amount and the budgeted rebate amount; and
causing the sales information to be displayed comprises causing a comparison of the used rebate amount and the budgeted rebate amount to be displayed in association with the distributor.

14. The method of claim 11, wherein causing the sales information to be displayed comprises:
determining that an agreement defining the plurality of rules is near or up for renewal;
causing at least a portion of the sales information that is related to the distributor to be displayed, to support a renewal decision-making process; and
receiving an indication of whether to renew the agreement.

15. The method of claim 1, further comprising:
receiving a set of proposed rules;
transmitting the set of proposed rules to an approval entity;
receiving an indication of approval of at least some of the set of proposed rules from the approval entity; and
in response to receiving the indication of approval, implementing the at least some of the set of proposed rules as the plurality of rules.

16. A computer system, comprising:
one or more processors; and
a memory system comprising one or more computer-readable media storing instructions that, when executed by at least one of the one or more processors, cause the computer system to perform operations, the operations comprising:
receiving one or more proposed rules related to an agreement with a distributor;
transmitting the one or more proposed rules to an approval entity;
receiving an indication of approval from the approval entity of the one or more proposed rules;
in response to receiving the indication of approval, establishing one or more rules based on the one or more proposed rules;
receiving a plurality of rebate requests comprising a plurality of fields, wherein the plurality of rebate requests are associated with the distributor;
normalizing the plurality of fields to generate a plurality of normalized fields; and
determining whether to issue a rebate by applying the one or more rules to the plurality of normalized fields.

17. The system of claim 16, wherein the proposed rules are received from a remote source over a network.

18. The system of claim 16, wherein the operations further comprise determining, using the processor, sales information related to sales activities of the distributor, based on the plurality of rebate requests.

19. The system of claim 18, wherein the operations further comprise:
determining that the agreement is near or up for renewal;
causing the sales information to be displayed;
receiving an indication to renew the agreement; and
modifying at least one of the one or more rules based on the indication to renew the agreement.

20. The system of claim 16, wherein the operations further comprise receiving a plurality of normalization rules from a manufacturer associated with the agreement, wherein normalizing the plurality of fields comprises applying the plurality of normalization rules.
